(19) United States
(12) Patent Application Publication
(10) Pub. No.: US 2007/0160135 A1
(43) Pub. Date: Jul. 12, 2007

(54) Multi-view video coding method and apparatus

(75) Inventors: Akio Ishikawa, Saitama (JP); Ryoichi Kawada, Saitama (JP); Atsushi Koike, Saitama (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KDDI CORPORATION, Tokyo (JP)

(21) Appl. No.: 11/638,462

(22) Filed: Dec. 14, 2006

(30) Foreign Application Priority Data
Jan. 6, 2006 (JP) 2006-001005

(51) Int. Cl. H04N 11/04; H04N 7/18

(52) U.S. Cl. 375/240.01; 348/159

(57) ABSTRACT

A multi-view video coding method comprises the steps of: collecting position information of the video cameras, determining one video camera as a base video camera among the video cameras, collecting sequences of synchronism from the video cameras, independently coding a sequence of the base video camera, predictively coding a sequence of a video camera adjacent to the video camera of a previously coded sequence, in reference to the previously coded sequence, repeating the predictive coding step for sequence of an adjacent video camera, till sequences of all video cameras are coded.

### PRIORITY CLAIM

The present application claims priority from Japanese Patent Application No. 2006-001005 filed on Jan. 6, 2006, which are incorporated herein by reference.

### BACKGROUND OF THE INVENTION

1. Field of the Invention

The present invention relates to a multi-view video coding method and apparatus.

2. Description of the Related Art

There is a related art of “free-viewpoint video” that an audience can select position or direction of a viewpoint freely. The free-viewpoint video is composed of pictures in which an object is shot by a plurality of video cameras of different viewpoints. A picture of a viewpoint that is not shot is generated by an interpolation. Thus, by shortening layout spacing of a plurality of video cameras, a free-viewpoint video of high quality is provided. Here, “a multi-view video coding” technique becomes necessary to code a plurality of pictures efficiently in a mass.

A moving image coding method generally uses an inter-frame prediction coding method to realize high coding rate using correlation of time. According to H.264 (motion compensation+Discrete Cosine Transform) of a representative moving image-coding method, there is I-picture (Intra-Picture), P-picture (Predictive-Picture) and B-picture (Bi-directional Predictive-Picture) as a coding mode of a frame.

I-picture is a picture coded independently regardless of a forward and backward picture. P-picture is a picture coded predictively between pictures in a forward direction. B-picture is a picture coded predictively in bidirection of a past picture and a future picture. B-picture uses future macro-blocks and/or past macro-blocks on time base. B-picture in H.264 can be predicted from two past pictures or two future pictures. Thus, it is called a bi-predictive picture.

FIG. 1 shows an illustration of coding of a picture shot by one video camera.

According to FIG. 1, picture frames arranged in a coding sequence and picture frames arranged in a representation order are shown. Since past macro-blocks are used as a reference picture, representation order is different from coding order.

FIG. 2 shows an illustration of a multi-view video coding method in the related art.

A sequence is independently coded for every video camera. Thus, the sequence includes I-picture. However, between picture frames shot at the same time by a plurality of video cameras of different positions, there is strong correlation except parallax error. Nevertheless I-picture is coded for every video camera. Thus, coding compression rate may be further improved.

A plurality of picture frames shot at the same time by video cameras of different positions are considered to be one sequence. This motion compensation is called “parallax error compensation”. There is a coding method compressing multi-view video by using parallax error compensation (for example, refer to JP-2005-260464-A2). A sequence of one video camera is coded by referring to a sequence of the other video camera.

According to patent document 1, if an Mth picture frame of an Nth sequence shot by an Nth video camera is B-picture, the Mth picture frame of an (N+1)th sequence is coded by referring to the Mth picture frame of the Nth sequence. In addition, if the Mth frame of the Nth sequence is I-picture or P-picture, the Mth picture frame of the (N+1)th sequence is coded by referring to the Mth picture frame of the Nth sequence.

The multi-view video coding method described in JP-2005-260464-A2 does not specify a sequence to be independently coded. However, when sequences to be independently coded are different, dimension of parallax error compensation in coding of all sequences is different, too. This influences coding rate.

### BRIEF SUMMARY OF THE INVENTION

Thus, an object of the present invention is to provide a multi-view video coding method and apparatus whose picture quality is maintained yet the amount of information is reduced.

According to the present invention, a multi-view video coding method for a coding apparatus connected to a plurality of video cameras placed in different positions, the method comprising the steps of collecting position information of the video cameras, determining one video camera as a base video camera among the video cameras, collecting sequences of synchronism from the video cameras, independently coding a sequence of the base video camera, predictively coding a sequence of a video camera adjacent to the video camera of a previously coded sequence, in reference to the previously coded sequence, repeating the predictive coding step for sequence of an adjacent video camera, till sequences of all video cameras are coded.

According to the present invention, for multi-view video coding method and apparatus, a parallax for the independently coded sequence can be lowered generally, picture quality can be maintained, and encoded information volume can be reduced.

It is preferred that the determining step develops position information of all video cameras on a coordinate, and determines a video camera near to mean position of position vector as the base video camera.

It is also preferred that based on H.264, the independent coding step includes I-picture in a coding frame of the base video camera, wherein the predictive coding step does not include I-picture in a coding frame of the adjacent video camera, and predictively coding an Mth frame of a sequence shot by the adjacent video camera, in reference to the Mth frame of the previously coded sequence.

According to the present invention, a multi-view video coding apparatus connected to a plurality of video cameras placed in different positions, comprising means for collecting position information of the video cameras, means for determining one base video camera as a base video camera among the video cameras, means for collecting sequences of synchronism from all the video cameras,

means for independently coding a sequence, means for predictively coding a sequence, in reference to a previously coded sequence, means for controlling predictive coding by repeating the following transferring a sequence of the base video camera to the independent coding means, transferring a sequence of a video camera adjacent to a video camera of the previously coded sequence to the predictive coding means, transferring a sequence of an adjacent video camera to the predictive coding means, till sequences of all video cameras are coded.

It is preferred that the determining means develops position information of all the video cameras on a coordinate, and determines a video camera near to mean position of position vector as the base video camera.

It is also preferred that based on H.264, the independent coding means includes I-picture in a coding frame of the base video camera, wherein the predictive coding means does not include I-picture in a coding frame of the adjacent video camera, and predictively coding an Mth frame of a sequence shot by the adjacent video camera, in reference to the Mth frame of the previously coded sequence.

According to the present invention, a method for causing a computer to function as a multi-view video coding device connected to a plurality of video cameras placed in different positions, the method comprising the steps of collecting position information of the video cameras, determining one video camera as a base video camera among the video cameras, collecting sequences of synchronism from the video cameras, independently coding a sequence of the base video camera, predictively coding a sequence of a video camera adjacent to the video camera of a previously coded sequence, in reference to the previously coded sequence, repeating the predictive coding step for sequence of an adjacent video-camera, till sequences of all video cameras are coded.

### BRIEF DESCRIPTION OF THE SEVERAL VIEWS OF THE DRAWINGS

FIG. 1 shows an illustration of coding of a picture shot by one video camera.

FIG. 2 shows an illustration of a multi-view video coding method in a related art.

FIG. 3 shows a system configuration diagram in the present invention.

FIG. 4 shows an illustration of a reference frame in the present invention.

FIG. 5 shows a flowchart of a multi-view video coding method in the present invention.

FIG. 6 shows a functional configuration diagram of a multi-view video coding apparatus in the present invention.

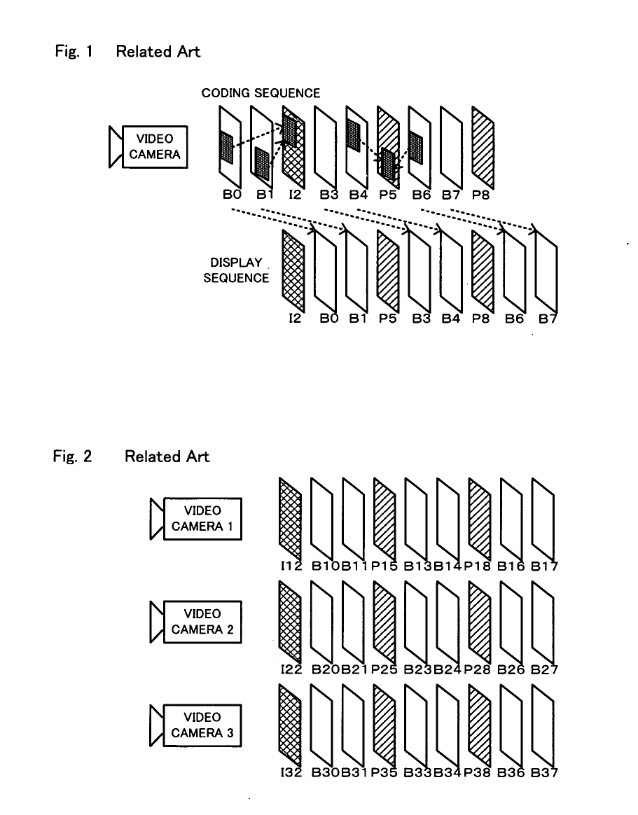

### DETAILED DESCRIPTION OF THE INVENTION

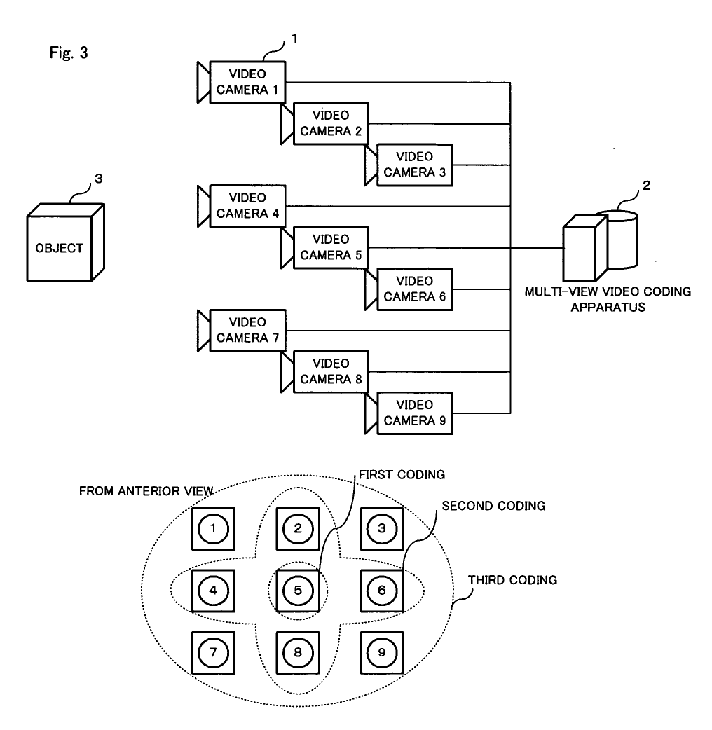

FIG. 3 shows a system configuration diagram in the present invention.

According to FIG. 3, an object 3 is shot by a plurality of video cameras 1-9 placed in different positions. The 9 video cameras are placed on the same plane by 3*3 matrices. In addition, the video cameras 1-9 are connected to a multi-view video coding apparatus 2.

The video cameras 1-9 send the sequences that the object 3 was shot, to the multi-view video coding apparatus 2. The video cameras 1-9 send camera position information to the multi-view video coding apparatus 2. The multi-view video coding apparatus 2 may store all camera position information previously.

According to FIG. 3, the positions of the video cameras 1-9 are developed on a coordinate. A coordinate is two dimensions or a three dimensions. Here, a mean of position vector in all video cameras 1-9 is calculated. Substantially, the position of this mean is the center of all video cameras 1-9 (for example, center of gravity). First, a sequence of the video camera that is nearest to this center location is independently coded. According to FIG. 3, a sequence of the video camera 5 is independently coded without referring to other sequences.

Second, a sequence of the video camera that is neighboring to the base video camera 5 is coded. It is usually preferable to select 2-4 adjacent video cameras. According to FIG. 3, the video cameras 2, 4, 6 and 8 that are neighboring to the video camera 5 are selected. Then, the sequences of the video cameras 2, 4, 6 and 8 are predictively coded by referring to the coded sequence of the base video camera 5.

Furthermore, the video cameras that are neighboring to the video cameras 2, 4, 6 and 8 are coded. A sequence of the video camera 1 that is neighboring to the video cameras 2 and 4 is predictively coded by referring to the coded sequences of the video cameras 5, 2 and 4.

In addition, a sequence of the video camera 3 that is neighboring to the video cameras 2 and 6 is predictively coded by referring to the coded sequences of the video cameras 5, 2 and 6.

In addition, a sequence of the video camera 7 that is neighboring to the video cameras 4 and 8 is predictively coded by referring to the coded sequences of the video cameras 5, 4 and 8. In addition, a sequence of the video camera 9 that is neighboring to the video cameras 6 and 8 is predictively coded by referring to the coded sequences of the video cameras 5, 6 and 8.

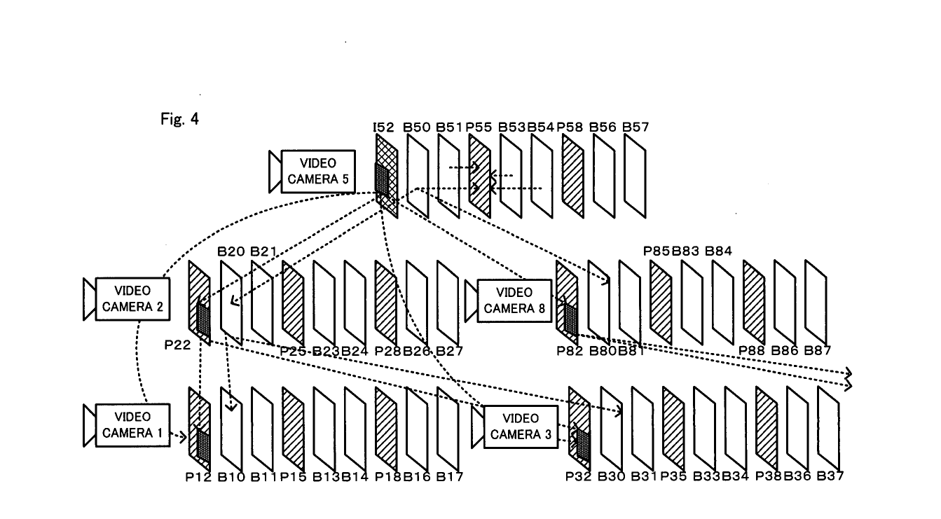

FIG. 4 shows an illustration of a reference frame in the present invention.

The configuration of video cameras of FIG. 4 is the same as FIG. 3. Thus, a sequence of the video camera 5 is independently coded. A sequence of the video camera 2 is predictively coded by referring to the coded sequence of the video camera 5. In addition, a sequence of the video camera 8 is predictively coded by referring to the coded sequence of the video camera 5. Furthermore, a sequence of the video camera 1 is predictively coded by referring to the coded sequences of the video cameras 5, 2 and 4. In addition, a sequence of the video camera 3 is predictively coded by referring to the coded sequences of the video cameras 5, 2 and 6.

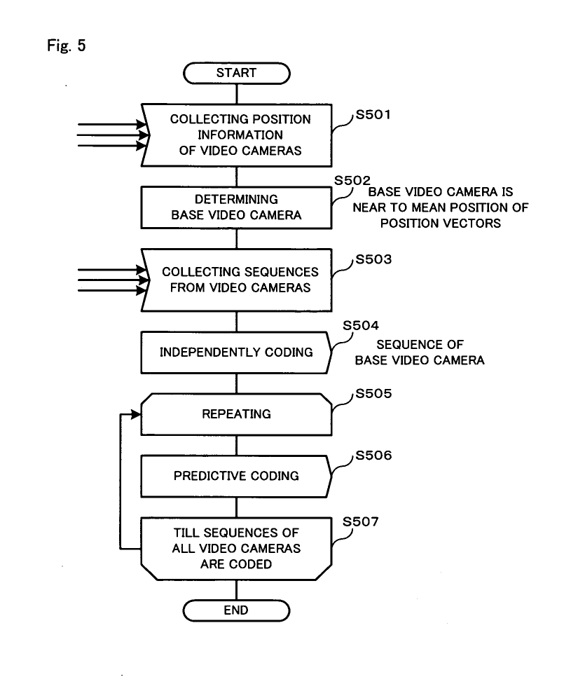

FIG. 5 shows a flowchart of the multi-view video coding method in the present invention.

(S501) Position information of all video cameras is collected. The video cameras may be movable. For example, if the video cameras include positioning facilities such as GPS, position information can be received. If the video cameras are fixed, the position information may be registered previously.

(S502) Among the video cameras, one video camera is determined as a base video camera. The position information of the all video cameras is developed on a coordinate. A video camera that is near to mean position of position vector is determined as a base video camera.

(S503) Sequences of synchronism are collected from the all video cameras.

(S504) The sequence of the base video camera is independently coded. According to H.264, the predictively coded sequence includes I-picture.

(S505) S506 and S507 are repeated.

(S506) A sequence of a video camera adjacent to a video camera of the previously coded sequence is predictively coded by referring to the previously coded sequence. A sequence of a second video camera adjacent to the base video camera is predictively coded by referring to the coded sequence of the base video camera.

Here, the predictively coded video frame does not include I-picture. In addition, an Mth frame in a sequence shot by the adjacent video camera is predictively coded by referring to the Mth frame in the previously coded sequence.

(S507) It is determined whether there is an adjacent camera of the sequence that is not coded. When there is the adjacent camera, it recurs to S505. Thus, a sequence of a third video camera adjacent to the second video camera is predictively coded by referring to the coded sequences of the base video camera and the second video camera.

It is similar as follows. An Nth coded sequence is not still coded in the sequences adjacent to an (N−1)th coded sequence. Not only the other frame in the same sequence is referred to, but also the same time frame in the sequences between first coded sequence and the (N−1)th coded sequence is referred to. For simplification, only a sequence to be adjacent to the sequence coded in the (N−1)th may be referred to.

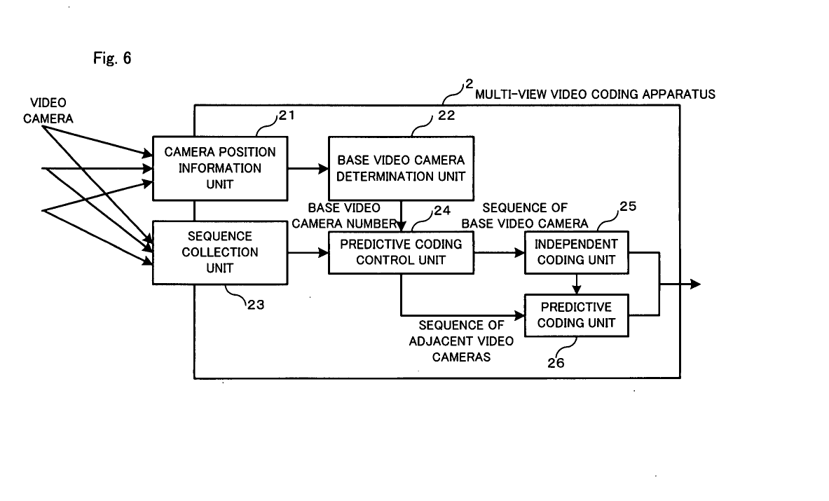

FIG. 6 shows a functional configuration diagram of a multi-view video coding apparatus in the present invention.

According to FIG. 6, a multi-view video coding apparatus 2 has a camera position information collecting unit 21, a base video camera determination unit 22, a sequence collection unit 23, a predictive coding control unit 24, an independent coding unit 25 and a predictive coding unit 26. A program to be executed with a computer can also realize these function units.

The camera position information collecting unit 21 collects position information of all video cameras. It has a function of S501 in FIG. 5.

Among the all video cameras, the base video camera determination unit 22 determines one video camera as a base video camera. The base video camera determination unit 22 develops position information of the all video cameras on a coordinate, and a video camera that is near to mean position of position vector is selected as a base video camera. It has a function of S502 in FIG. 5.

The sequence collection unit 23 collects sequences of synchronism from the all video cameras. It has a function of S503 in FIG. 5.

The independent coding unit 25 codes a sequence independently. A coding frame of the base video camera includes I-picture. It has a function of S504 in FIG. 5.

The predictive coding unit 26 refers to the previously coded sequence, and predictive coding is performed. It has a function of S506 in FIG. 5.

The predictive coding control unit 24 transfers a sequence of the base video camera to the independent coding unit 25. In addition, a sequence of a video camera adjacent to a video camera of the previously coded sequence is transferred to the predictive coding unit 26. Subsequently, till sequences of all video cameras are coded, it is repeated that a sequence of an adjacent video camera is transferred to the predictive coding unit 26. It has a function of S505 and S507 in FIG. 5.

According to the present invention, for multi-view video coding method and apparatus, a parallax for the independently coded sequence can be lowered generally, picture quality can be maintained, and encoded information volume can be reduced.

Many widely different embodiments of the present invention may be constructed without departing from the spirit and scope of the present invention. It should be understood that the present invention is not limited to the specific embodiments described in the specification, except as defined in the appended claims.

The invention claimed is:

1. A multi-view video coding method for a coding apparatus connected to a plurality of video cameras placed in different positions, said method comprising the steps of:
collecting position information of said video cameras,
determining one video camera as a base video camera among said video cameras,
collecting sequences of synchronism from said video cameras,
independently coding a sequence of said base video camera,
predictively coding a sequence of a video camera adjacent to said video camera of a previously coded sequence, in reference to said previously coded sequence,
repeating said predictive coding step for sequence of an adjacent video camera, till sequences of all video cameras are coded.

2. The method as claimed in claim 1, wherein said determining step develops position information of all video cameras on a coordinate, and determines a video camera near to mean position of position vector as said base video camera.

3. The method as claimed in claim 1, wherein based on H.264, said independent coding step includes I-picture in a coding frame of said base video camera,
wherein said predictive coding step does not include I-picture in a coding frame of said adjacent video camera, and predictively coding an Mth frame of a sequence shot by said adjacent video camera, in reference to the Mth frame of said previously coded sequence.

4. A multi-view video coding apparatus connected to a plurality of video cameras placed in different positions, comprising:
means for collecting position information of said video cameras,
means for determining one base video camera as a base video camera among said video cameras,
means for collecting sequences of synchronism from all said video cameras,
means for independently coding a sequence,
means for predictively coding a sequence, in reference to a previously coded sequence,
means for controlling predictive coding by repeating the following:
transferring a sequence of said base video camera to said independent coding means,
transferring a sequence of a video camera adjacent to a video camera of said previously coded sequence to said predictive coding means,
transferring a sequence of an adjacent video camera to said predictive coding means, till sequences of all video cameras are coded.

5. The apparatus as claimed in claim 4, wherein said determining means develops position information of all said video cameras on a coordinate, and determines a video camera near to mean position of position vector as said base video camera.

6. The apparatus as claimed in claim 4, wherein based on H.264, said independent coding means includes I-picture in a coding frame of said base video camera,
wherein said predictive coding means does not include I-picture in a coding frame of said adjacent video camera, and predictively coding an Mth frame of a sequence shot by said adjacent video camera, in reference to the Mth frame of said previously coded sequence.

7. A method for causing a computer to function as a multi-view video coding device connected to a plurality of video cameras placed in different positions, said method comprising the steps of:
collecting position information of said video cameras,
determining one video camera as a base video camera among said video cameras,
collecting sequences of synchronism from said video cameras,
independently coding a sequence of said base video camera,
predictively coding a sequence of a video camera adjacent to said video camera of a previously coded sequence, in reference to said previously coded sequence,
repeating said predictive coding step for sequence of an adjacent video camera, till sequences of all video cameras are coded.
